(19) United States
(12) Patent Application Publication
(10) Pub. No.: US 2015/0266999 A1
(43) Pub. Date: Sep. 24, 2015

(54) INSOLUBILIZATION OF WATER-SOLUBLE POLYARAMIDE BY CROSS-LINKING WITH POLYFUNCTIONAL AZIRIDINE

(71) Applicant: Light Polymers B.V., Amsterdam (NL)

(72) Inventors: Valeriy Kuzmin, San Bruno, CA (US); David Taft, Traverse City, MI (US); Louis Cohen, Henderson, NV (US)

(21) Appl. No.: 14/533,782

(22) Filed: Nov. 5, 2014

Related U.S. Application Data
(60) Provisional application No. 61/954,626, filed on Mar. 18, 2014.

(51) Int. Cl. C08G 69/48; G02B 1/04; G02B 1/10; C09D 177/06

(52) U.S. Cl. CPC C08G 69/48; C09D 177/06; G02B 1/04; G02B 1/10

(57) ABSTRACT

Compositions including a polyaramide cross-linked with a polyfunctional bridging group; compositions including a layer of a water-soluble polyaramide and a layer of a polyfunctional bridging group on the layer of water-soluble polyaramide; and methods of making and using those compositions are described. The compositions can be formed from water-soluble polyaramides and polyfunctional aziridine. The compositions can form components, films, and coatings. The compositions can be included in optical elements.

### RELATED APPLICATION

This application claims the benefit under 35 U.S.C. §119(e) of U.S. Provisional Patent Application No. 61/954,626, filed on Mar. 18, 2014, and titled INSOLUBILIZATION OF HYDROPHILIC COATINGS WITH POLYFUNCTIONAL AZIRIDINE, which is hereby incorporated by reference in its entirety.

### BACKGROUND

Currently, polymers are used for many optical applications because of their low cost, certain optical characteristics (such as transparency), and ease of processing. Polymer materials may be used for fiber optics, standard optics, and displays. For example, poly(methyl methacrylate) (PMMA), polycarbonate, polyethylene terephthalate (PET), and polystyrene can be used to form lenses; illumination panels; film substrates; optical fibers; and components of liquid crystal displays (LCDs), including backlights.

The optical characteristics of polymers are not ideal for all applications. For example, in some applications, the refraction characteristics of polymers are not optimal. In another example, the market is demanding thinner films and components, and existing polymers may not be able to meet this demand.

### SUMMARY

The present disclosure relates to a water-insoluble composition including polyaramide segments covalently cross-linked to other polyaramide segments. In many embodiments, the composition includes a polyaramide that has been cross-linked by polyfunctional aziridine. Coatings, films, or components formed from water-soluble polyaramides can be used for many applications such as flat panel displays, including LCD and organic light-emitting diode (OLED); LED lighting; solar; ion exchange membranes; flexible printed circuit films; and barrier films for electronics. In some applications, including, for example some displays, it is preferable that water be excluded from contacting other components. In one embodiment, polyfunctional aziridine is used to cross-link a water-soluble polyaramide, thereby reducing water-solubility of the polyaramide. In another embodiment, polyfunctional aziridine is cross-linked to form an overcoat for a water-soluble polyaramide. In yet another embodiment, polyfunctional aziridine is used to form an overcoat for a polyaramide, and the aziridine cross-links the polyaramide at the interface between the layers.

In some embodiments, the present disclosure relates to a water-insoluble composition including polyaramide segments covalently cross-linked to other polyaramide segments wherein a covalently cross-linked segment includes

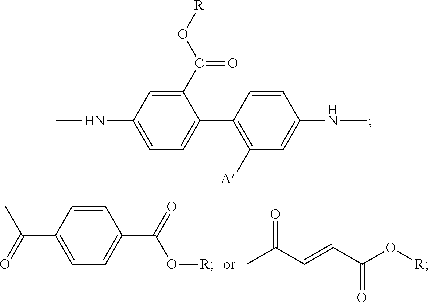

wherein R is a polyfunctional bridging group that includes only covalent bonded fragments; and A′ is independently selected from SO₃H, SO₃⁻, COOH, COO⁻, or COOR, or salts thereof. In some embodiments, A′ further includes a sulfonic salt or a carboxy salt. In some embodiments, R is covalently bonded to at least two polyaramide segments. In some embodiments, R includes a reaction product of a polyfunctional aziridine. In some embodiments R includes

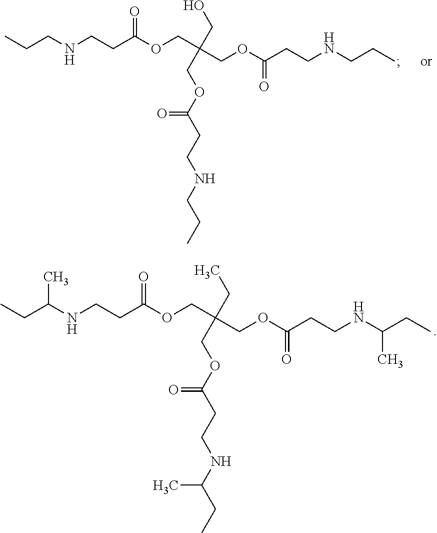

In some embodiments, the water-insoluble composition further includes a volatile base.

In some embodiments, a film, coating, or optical element includes the water-insoluble composition including cross-linked polyaramide segments. In some embodiments, the film or the coating can be optically anisotropic.

In some embodiments, the polyaramide of the water-insoluble composition includes at least one of the following segments:

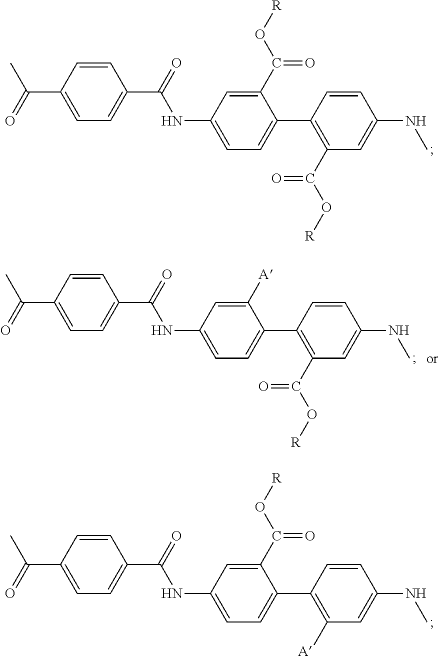

wherein R is a polyfunctional bridging group that includes only covalent bonded fragments, and A′ is independently selected from SO₃H, SO₃⁻, COOH, COO⁻, or COOR, or salts thereof

In some embodiments, the polyaramide of the water-insoluble composition includes

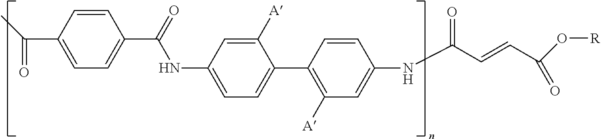

wherein n is an integer between 2 and 10,000; R is a polyfunctional bridging group that includes only covalent bonded fragments; and A′ is independently selected from SO₃H, SO₃⁻, COOH, COO⁻, or COOR, or salts thereof.

In some embodiments, the polyaramide of the water-insoluble composition includes a copolymer including a first segment including:

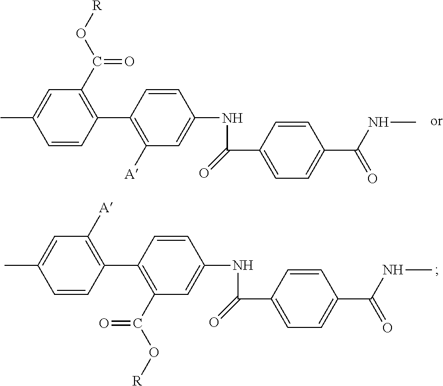

and a second segment including:

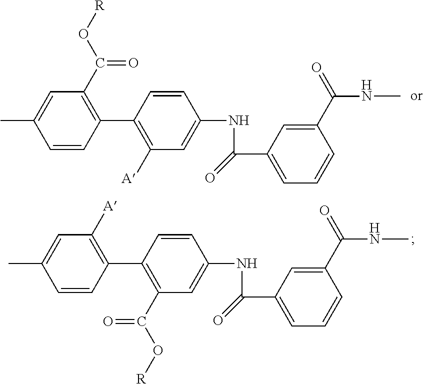

wherein R is a polyfunctional bridging group that includes only covalent bonded fragments; A′ is independently selected from SO₃H, SO₃⁻, COOH, COO⁻, or COOR, or salts thereof; and further wherein the first segment and the second segment are connected by a covalent bond.

In some embodiments, the present disclosure relates to an article including a first layer including a polyaramide; and a second layer including a polyfunctional bridging group, wherein the second layer is adjacent to the first layer at an interface. In some embodiments, the polyfunctional bridging groups of the article are covalently bonded to the polyaramides at the interface. In some embodiments, an optical element can include the article.

In some embodiments, the polyaramide of the article includes at least one of the following segments:

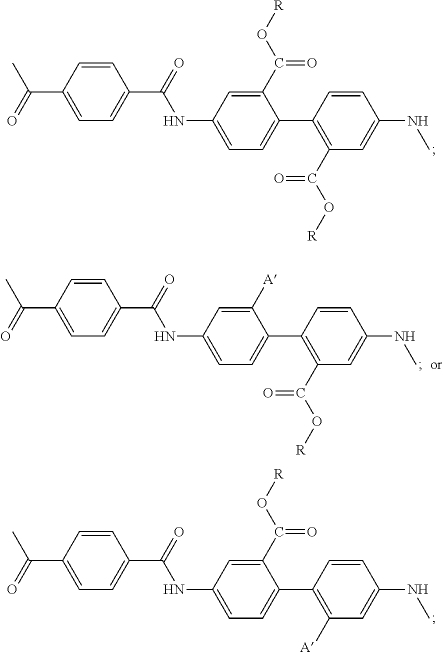

wherein R is a polyfunctional bridging group that includes only covalent bonded fragments and A′ is independently selected from SO₃H, SO₃⁻, COOH, COOH⁻, or COOR, or salts thereof

In some embodiments, the polyaramide of the article includes a copolymer including a first segment including:

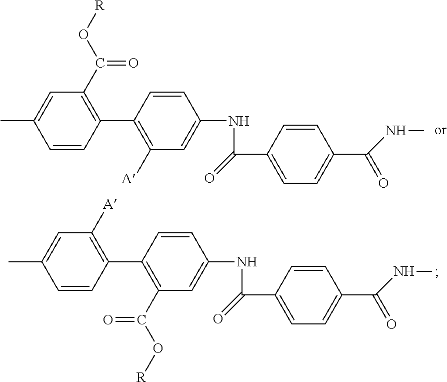

and a second segment including:

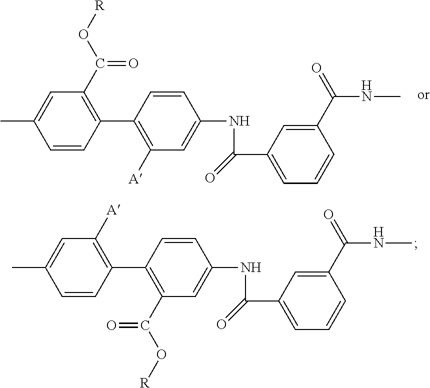

wherein R is a polyfunctional bridging group that includes only covalent bonded fragments and A′ is independently selected from SO₃H, SO₃⁻, COOH, COOH⁻, or COOR, or salts thereof. In one aspect, the first segment and the second segment are connected by a covalent bond.

In some embodiments the present disclosure relates to a method including combining a water-soluble polyaramide including a carboxylic acid group with a polyfunctional aziridine to form a mixture and cross-linking the water-soluble polyaramide with the polyfunctional aziridine contained within the mixture. In one aspect, the method forms a water-insoluble polyaramide. In many embodiments, the method further includes adding a volatile base to the mixture. In some aspects, the method further includes shear coating the mixture on a substrate. The method can include coating the mixture on an optical element or substrate. The substrate can be an optical element or a release layer for a coating. In many embodiments, the coating can form part of or all of an optical element. In some embodiments, the cross-linking includes heating the mixture and/or reducing the pH of the mixture.

In one aspect, the polyaramide comprises

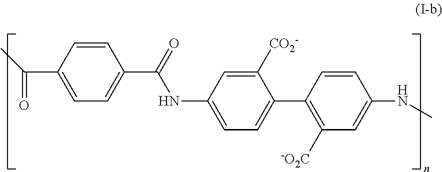

wherein n is an integer between 2 and 10,000.

In one aspect, the polyaramide includes a copolymer including a segment including the following formula:

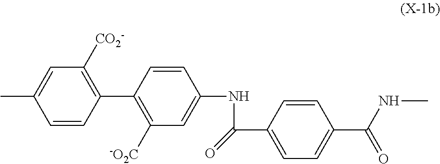

and a segment including the following formula:

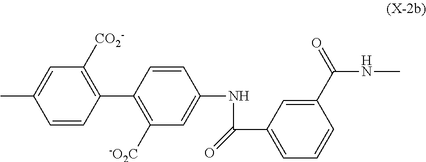

wherein the segments are connected by a covalent bond.

In one aspect, the method further includes coating a layer of polyfunctional aziridine onto the mixture before the cross-linking step and cross-linking the layer of polyfunctional aziridine simultaneously with the cross-linking step. In another aspect, the method further includes coating a layer of polyfunctional aziridine onto the mixture after the cross-linking step and then cross-linking the layer of polyfunctional aziridine.

In some embodiments the present disclosure relates to an optical element formed by a method including combining a water-soluble polyaramide including a carboxylic acid group with a polyfunctional aziridine to form a mixture; and cross-linking the water-soluble polyaramide with the polyfunctional aziridine contained within the mixture.

These and various other features and advantages will be apparent from a reading of the following detailed description.

### BRIEF DESCRIPTION OF THE FIGURES

FIGS. 1A and 1B show a photograph of a slide coated with a composition including polyaramide segments during (FIG. 1A) and after (FIG. 1B) treatment with an aqueous solvent. This set of images demonstrates an example of an insoluble coating (a solubility rating of 1, “stable”, see Table 3).

FIGS. 2A and 2B show a photograph of a slide coated with a composition including polyaramide segments during (FIG. 2A) and after (FIG. 2B) treatment with an aqueous solvent. This set of images demonstrates an example of a mostly insoluble coating (a solubility rating of 2, “defect—surface unbroken”, see Table 3).

FIGS. 3A and 3B show a photograph of a slide coated with a composition including polyaramide segments during (FIG. 3A) and after (FIG. 3B) treatment with an aqueous solvent. This set of images demonstrates an example of a coating of limited insolubility (a solubility rating of 3, “defect—surface broken”, see Table 3).

FIGS. 4A and 4B show a photograph of a slide coated with a composition including polyaramide segments during (FIG. 4A) and after (FIG. 4B) treatment with an aqueous solvent. This set of images demonstrates an example of a completely soluble coating (a solubility rating of 4, “hole”, see Table 3).

The disclosure may be more completely understood in consideration of the following detailed description of various embodiments of the disclosure in connection with the accompanying drawings.

### DETAILED DESCRIPTION

In the following detailed description, examples are provided and reference is made to the accompanying figures that form a part hereof by way of illustration of several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising,” and the like.

In this disclosure:

“thermally stable” refers to materials that remain substantially intact at 100 degrees Celsius;

“water soluble” or “water-soluble” refers to a material that, being in the form of dry coating of thickness of 100 nm to 10,000 nm on glass substrate, is completely removed in the course of a Water Drop Test that involves applying 1 g of water at room temperature onto the coating and keeping water in contact with the coating for 5 min.

“water insoluble” or “water-insoluble” refers to a material that, after the Water Drop Test, maintains its integrity (no defects, no thinning, no marring) and retains the optical properties such as transparency and retardation it possessed before the Water Drop Test.

“refractive index” or “index of refraction,” refers to the absolute refractive index of a material that is understood to be the ratio of the speed of electromagnetic radiation in free space to the speed of the radiation in that material. The refractive index can be measured using known methods and is generally measured using an Abbe refractometer in the visible light region (available commercially, for example, from Fisher Instruments of Pittsburgh, Pa.). It is generally appreciated that the measured index of refraction can vary to some extent depending on the instrument;

“optical element” is any element that has an optical function, such as transmitting light, diffusing light, polarizing light, recycling light, and the like. The optical element can be made of glass, silicon, quartz, sapphire, plastic, and/or a polymer. The polymer can be, for example, poly(methyl methacrylate), polycarbonate, polystyrene, cyclic olefin copolymer, or amorphous polyolefin. The optical element can be in the form of a film, lens, sheet, plate, and the like.

The present disclosure relates to a polyfunctional aziridine cross-linked water-soluble polyaramide. In one embodiment, a water-soluble polyaramide is cross-linked by polyfunctional aziridine to reduce water-solubility of a film or coating formed from the polyaramide. In another embodiment, polyfunctional aziridine is cross-linked to form an overcoat for a water-soluble polyaramide. In yet another embodiment, polyfunctional aziridine is cross-linked with a water-soluble polyaramide and used to form an overcoat for cross-linked polyaramide.

While the present disclosure is not so limited, an appreciation of various aspects of the disclosure will be gained through a discussion of the examples provided below.

Water-Soluble Polyaramides

A water-soluble polyaramide can be used to form an optical element, a portion of an optical element, a film, or a coating. A polyaramide is an aromatic polyamide. In some conditions, the water-soluble polyaramide may form an anisotropic or liquid crystal material.

The film may be formed, for example, as described in Cohen, E. & Gutoff, E. Modern Coating and Drying Technology, Wiley-VCH, 1992. In some embodiments, a film formed from a water-soluble polyaramide may be an anisotropic optical film. In some embodiments, a coating or layer formed from a water-soluble polyaramide may be anisotropic, optically anisotropic, and/or macroscopically anisotropic. In some embodiments, the film, coating, or layer can have a regular or repeating structure. This regular or repeating structure can be at the molecular level. In some embodiments, the film, coating, or layer can have orientational order.

If the film is formed from a lyotropic liquid crystal state, sheer stress may be needed to align the molecules. In some embodiments, a film or coating formed from a water-soluble polyaramide may be formed on a substrate or on a release surface.

The water-soluble polyaramides may be polymers, and/or lyotropic liquid crystals. Polymers can include, for example, copolymers and block copolymers.

In some embodiments, the liquid crystal material described herein can be referred to as a “lyotropic liquid crystal” material. A liquid crystalline material is called “lyotropic” if phases having long-ranged orientational order are induced by the addition of a solvent, such as water. The term can be used to describe materials composed of amphiphilic molecules. Such molecules include a water-loving “hydrophilic” head-group (which may be ionic or non-ionic) attached to a water-hating “hydrophobic” group. Typical hydrophobic groups are saturated or unsaturated hydrocarbon chains.

Exemplary polymer segments include a copolymer that includes a segment including the following general formula:

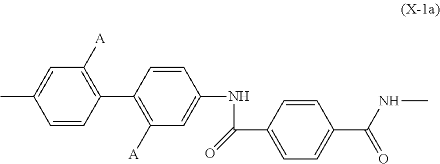

and a segment including the following general formula:

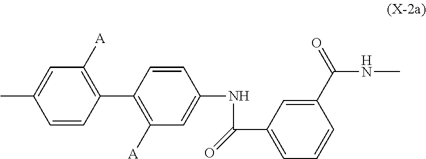

wherein A is independently selected from SO₃H or COOH, or a sulfonic or carboxy salt of an alkali metal, ammonium, quaternary ammonium, alkaline earth metal, Al³⁻, La³⁺, Fe³⁺, Cr³⁺, Mn²⁺, Cu²⁺, Zn²⁺, Pb²⁻ or Sn²⁺; and wherein at least one segment of formula (X-1a) and one segment of formula (X-2a) are connected by a covalent bond. The polymer segment may include a single segment of formula (X-1a) bonded to a single segment of formula (X-2a) or mixed segments of formula (X-1a) and formula (X-2a). In one embodiment, the ratio of segments of formula (X-1) to segments of formula (X-2) is about 73:27. In other embodiments, the ratio of segments can be 0:100, 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, 99:1, 100:0 or any ratio in between, or range of these ratios. In some embodiments, the number-average molecular weight can be between 2,000 and 50,000, between 2,000, and 10,000, or between 4,000 and 6,000, and the number-average molecular weight is about 5000.

In one embodiment, A can be SO₃⁻ and/or COO⁻, wherein 0%, 3%, 4%, 5%, 8%, 10%, 15%, 20%, 25%, 30%, 35%, 40%, 45%, 50%, 60%, 70%, 80%, 90%, 95%, or 100% of A is SO₃⁻ and 100%, 97%, 96%, 95%, 92%, 90%, 85%, 80%, 75%, 70%, 65%, 60%, 55%, 50%, 40%, 30%, 20%, 10%, 5%, or 0% of A is COO⁻.

For example, in one embodiment the polymer segments include a segment including the following formula:

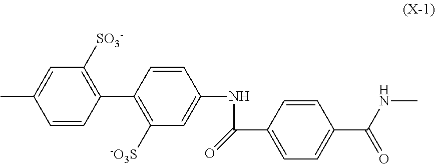

and a segment including the following formula:

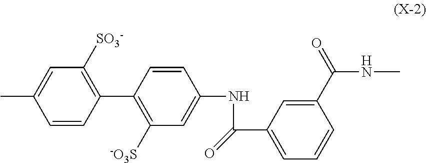

wherein at least one segment of formula (X-1) and one segment of formula (X-2) are connected by a covalent bond. For example, the polymer segments can include a segment including the following formula:

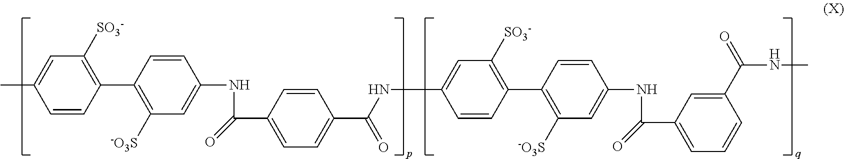

wherein p is an integer greater than or equal to 1 and q is an integer greater than or equal to 1.

Examples of synthesis of a polymer including these segments, 2,2′-disulfo-4,4′-benzidine terephthalamide-isophthalamide copolymer, are described in U.S. Publication No. 2010/0190015. A film formed from this polymer is birefringent and has the following refractive indices: nₓ=n_{y}=1.7 and n_{z}=1.5, where nₓ and n_{y} correspond to two mutually perpendicular directions in a plane and n_{z} corresponds to the normal direction to the plane of the substrate. In one embodiment, the ratio of segments of formula (X-1) to segments of formula (X-2) is about 73:27. In other embodiments, the ratio of segments can be 0:100, 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, 99:1, 100:0 or any ratio in between, or range of these ratios. In some embodiments, the number-average molecular weight can be between 2,000 and 50,000, between 2,000, and 10,000, or between 4,000 and 6,000, and the number-average molecular weight is about 5000.

For example, in one embodiment the polymer segments include a segment including the following formula:

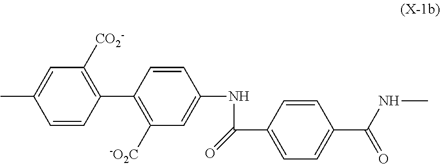

and a segment including the following formula:

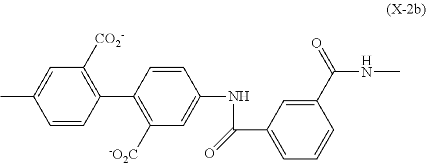

wherein at least one segment of formula (X-1b) and one segment of formula (X-2b) are connected by a covalent bond.

In many embodiments, the polymer has a molecular weight from 3000 to 30000 or from 3500 to 10000 or from 5000 to 7000, for example.

For example, in one embodiment, the polymer segments include a segment including the following formula:

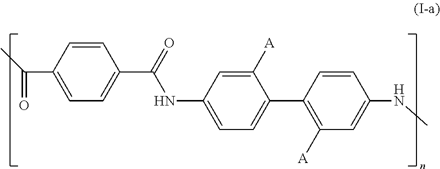

wherein A is independently selected from SO₃H or COOH, or a sulfonic or carboxy salt of an alkali metal, ammonium, quaternary ammonium, alkaline earth metal, Al³⁻, La³⁺, Fe³⁺, Cr³⁺, Mn²⁺, Cu²⁺, Zn²⁺, Pb²⁺ or Sn²⁺; and wherein n is an integer between 2 and 10,000. In some embodiments, n is at least 5.

In one embodiment, A can be SO₃⁻ and/or COO⁻, wherein 3%, 4%, 5%, 8%, 10%, 15%, 20%, 25%, 30%, 35%, 40%, 45%, 50%, 60%, 70%, 80%, 90%, 95%, or 100% of A is SO₃⁻ and 97%, 96%, 95%, 92%, 90%, 85%, 80%, 75%, 70%, 65%, 60%, 55%, 50%, 40%, 30%, 20%, 10%, 5%, or 0% of A is COO⁻.

In one embodiment, the polymer segments include a segment including the following formula:

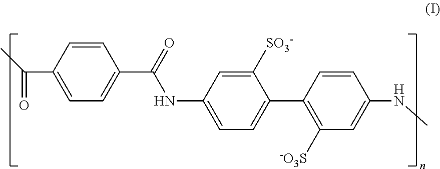

wherein n is an integer between 2 and 10,000. Examples of a synthesis of this molecule where n is at least 2, poly(2,2′-disulfo-4,4′-benzidine terephthalamide), are described in U.S. Pat. No. 8,512,824. In one embodiment, the number-average molecular weight is about 10,000 to about 150,000. In another embodiment, the number-average molecular weight is about 50,000 to about 150,000.

In an alternative embodiment, the polymer segments include a segment including (2,2′-dicarboxy)-4,4′-benzidine terephthalamide) or poly((2,2′-dicarboxy)-4,4′-benzidine terephthalamide):

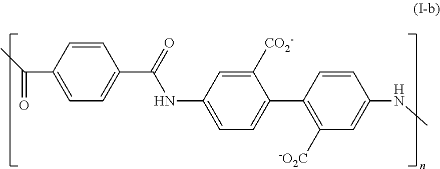

wherein n is an integer between 2 and 10,000. In one embodiment, the number-average molecular weight is about 50,000 to about 150,000.

In an alternative embodiment, the polymer segments include a segment including

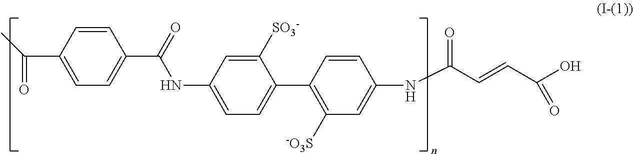

wherein n is an integer between 2 and 10,000.

In yet another embodiment, the polymer segments include a segment including

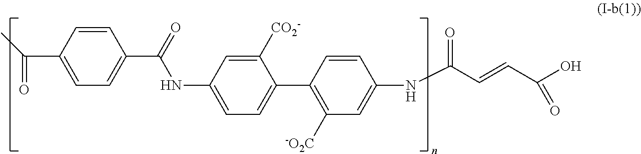

wherein n is an integer between 2 and 10,000.

Films of water-soluble polyaramides can be stabilized by treatment with a water-soluble inorganic salt, for example, an inorganic salt, as described in, for example, EP 2,279,233 B1 Films of water-soluble polyaramides cross-linked with polyfunctional aziridine can be used for at least the same applications as films stabilized using inorganic salt treatment.

Polyfunctional Aziridine

Polyfunctional aziridine cross-linking can provide a film or a coating made of water-soluble polyaramide with reduced solubility or resistance to water. In another aspect, polyfunctional aziridine cross-linking provides a more efficient means of stabilizing a water-soluble polyaramide. In contrast to stabilization of a water-soluble polyaramide with salt—which requires a film to be formed, dried, and then treated with salt—a film may be treated with a polyfunctional aziridine during film formation or before film drying. Stabilization of a water-soluble polyaramide with salt is accomplished with ionic bonding while stabilization with with polyfunctional aziridine is accomplished with covalent bonding. Additionally or alternatively, a coating of a water-soluble polyaramide cross-linked with polyfunctional aziridine may be used as a coating on a previously formed film, optical element, or substrate.

The polyfunctional aziridine has at least two aziridine functional groups, and preferably has at least three aziridine functional groups. The aziridine functional groups have the following general structure or are derived from:

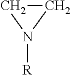

Hydrogen atoms in the structure shown above can be substituted with alkyl groups, including, for example, a methyl group.

Typically the polyfunctional aziridine includes from 3 to 5 nitrogen atoms per molecule.

Examples include N-(aminoalkyl) aziridines such as N-aminoethyl-N-aziridilethylamine, N, N-bis-2-aminopropyl-N-aziridilethylamine, N-3,6,9-triazanonylaziridine; pentaerythritol-tris-3-(1-aziridinyl)-propionate; and trimethylolpropane tris-(2-methyl-1-aziridine propionate). The polyfunctional aziridine can be one or both of the following tri-functional aziridines with structures corresponding to the structures, below:

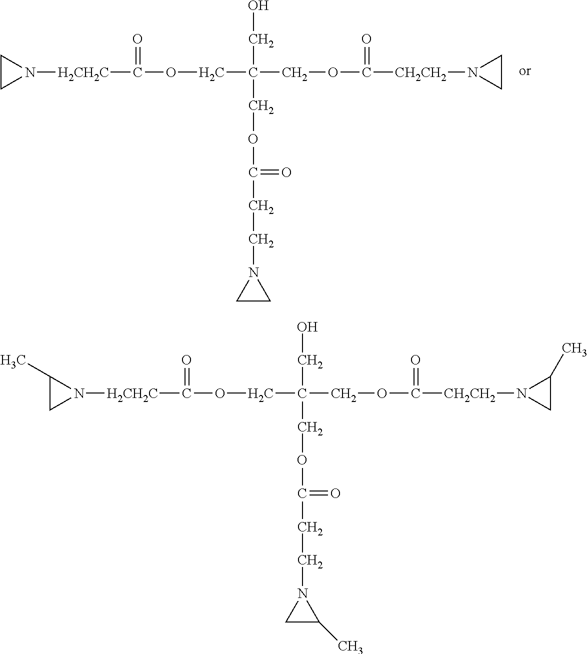

Polyfunctional aziridines with the above structures are commercially available from PolyAziridine, LLC, Medford, NJ.

Additional polyfunctional aziridine compounds are disclosed in U.S. Pat. No. 4,278,578, and U.S. Pat. No. 4,605,698.

Cross-Linking Water-Soluble Polyaramides with Polyfunctional Aziridine

In one embodiment, a water-soluble polyaramide is cross-linked with polyfunctional aziridine.

In some embodiments, for example, a water-soluble polyaramide is mixed with a polyfunctional aziridine to form a mixture. In some embodiments, a volatile base is added to the mixture. In some embodiments, the pH of the mixture after a volatile base is added can be 8 to 10. Upon a decrease in pH, covalent bonds form more quickly between the polyfunctional aziridine and the water-soluble polyaramide. In some embodiments, the mixture can be used to form a film, a coating, or an optical element. In some embodiments, the mixture can be coated onto an optical element or substrate before or after the pH is decreased. In many embodiments, the mixture is coated onto an optical element or substrate before covalent bonds form between the polyfunctional aziridine and the water-soluble polyaramide. The substrate can be an optical element or a release layer for a coating. In many embodiments, the coating formed from the mixture can form part of or all of an optical element. In one embodiment, the mixture is coated on a substrate and heated; as the base evaporates, pH decreases. In one embodiment, the mixture can be coated onto an optical element or substrate, and the coated mixture can be heated. In another embodiment, the mixture can be coated onto an optical element or substrate, allowed to dry, and then exposed to acid vapors or dipped into a solution of acid.

In some embodiments, the amount of polyfunctional aziridine can may be added according to the following calculations:

Equivalence 1=(% solids)*(% COOH)*[(Mw AZ Molecule/AZ Functionality)/(Mw Polymer Link/Polymer Functionality)]

Equivalence 2=2[(% solids)*(% COOH)*[(Mw AZ Molecule/AZ Functionality)/(Mw Polymer Link/Polymer Functionality)]]

In some embodiments, the cross-linking reaction comprises the following reaction:

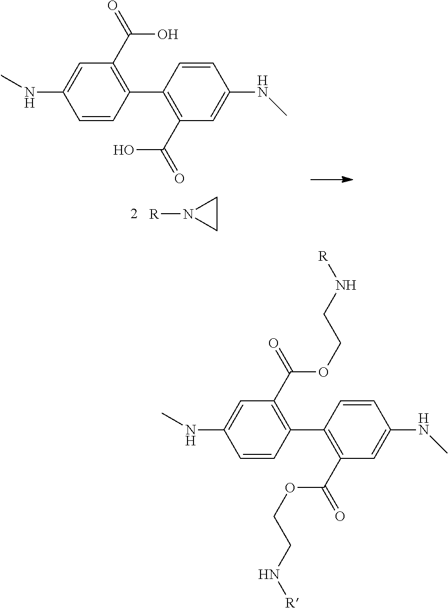

The volatile base can be ammonia, aqueous ammonia (NH₃ (Aq)); ammonium hydroxide; a tertiary amine including, for example, trimethyl amine, or triethylamine (TEA), trimethyl amine (TMA), dimethyl ethyl amine (DMEA), dimethyl iso-propylamine (DMIPA), dimethyl-n-propylamine (DMPA); or a hydroxylamine including, for example, dimethylethanolamine, or dimethyl propanol amine.

In some embodiments, the mixture can be coated onto an optical element or substrate. In some embodiments, a film or coating made of a water-soluble polyaramide is formed. The film or coating may be formed before, during, or after the addition of a volatile base to a mixture of a water-soluble polyaramide and a polyfunctional aziridine. The film or coating may be formed by coating a mixture containing a water-soluble polyaramide and aziridine onto an optical element or substrate. The mixture may further include a volatile base. In some embodiments, the film or coating is dried. In one embodiment, the mixture is dried by heating the mixture after coating on an optical element or a substrate.

In one aspect, the ability of a water-soluble polyaramide and/or polymer to react with polyfunctional aziridine is dependent on the presence of a carboxylic acid group in the polyaramide to react with aziridine. In one embodiment, a carboxylic acid is substituted for a sulfonic acid group of a polyaramide. Some or all of the sulfonic acid groups of a polymer and/or a polyaramide may be replaced with a carboxylic acid group. In another embodiment, a carboxylic acid group may be added at a terminus of a polymer and/or a polyaramide, for example as a part of a cap. In one embodiment, a maleic acid cap is added to a terminus of a polymer and/or a polyaramide. In one aspect, the polymer and/or polyaramide must be water-soluble to react with the polyfunctional aziridine in an aqueous solution.

In many embodiments, a water-soluble polyaramide is cross-linked with polyfunctional aziridine to form cross-linked water-insoluble polyaramide. In some embodiments, polyfunctional aziridine reacts with itself to form polyaziridine.

In some embodiments, the properties of a composition, film, or coating containing the reaction product of a polyaramide and a polyfunctional aziridine can be altered by altering the number of available carboxylic acid groups in the polyaramide. In some embodiments, the water-solubility of a composition, film, or coating containing the polyaramide can be altered by altering the number of available carboxylic acid groups in the polyaramide.

In some embodiments, a composition that includes polyaramide segments covalently cross-linked to other polyaramide segments can be formed by cross-linking a water-soluble polyaramide with polyfunctional aziridine. In some embodiments, a composition that includes polyaramide segments covalently cross-linked to other polyaramide segments can include one or more of the following segments:

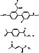

wherein R is a polyfunctional bridging group that comprises only covalent bonded fragments, and A′ is independently selected from SO₃H, SO₃⁻, COOH, COO⁻, or COOR, or salts thereof. In some embodiments, R is covalently bonded to at least 2 polyaramide segments; alternatively and additionally, R can be covalently bonded to 2, 3, 4, 5, or 6 polyaramide segments. In some embodiments, R comprises the reaction product of a polyaziridine. In some embodiments, R can include

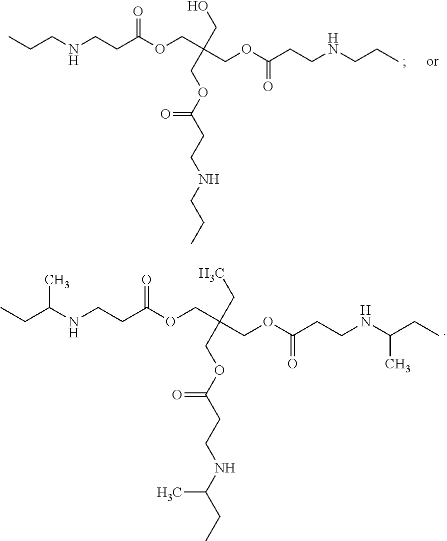

In some embodiments, the polyaramide of a composition that includes polyaramide segments covalently cross-linked to other polyaramide segments can include at least one of the following segments:

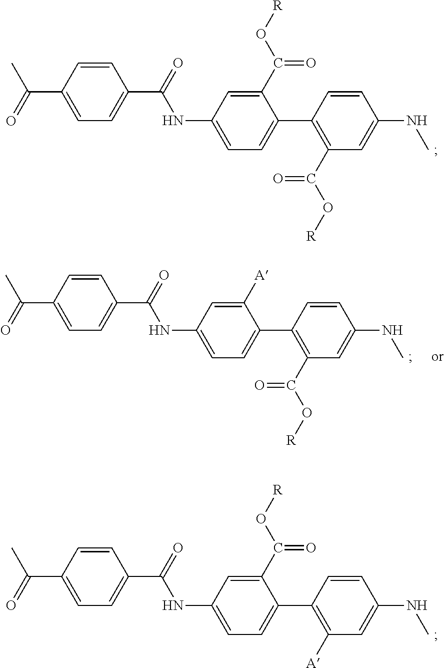

wherein R is a polyfunctional bridging group that comprises only covalent bonded fragments, and A′ is independently selected from SO₃H, SO₃⁻, COOH, COO⁻, or COOR, or salts thereof

In some embodiments, the polyaramide of a composition that includes polyaramide segments covalently cross-linked to other polyaramide segments can include

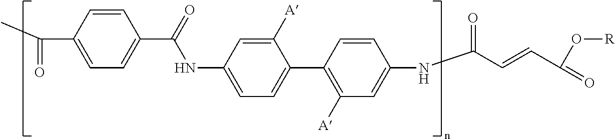

wherein n is an integer between 2 and 10,000; R is a polyfunctional bridging group that comprises only covalent bonded fragments; and A′ is independently selected from SO₃H, SO₃⁻, COOH, COO⁻, or COOR, or salts thereof.

In some embodiments, the polyaramide of a composition that includes polyaramide segments covalently cross-linked to other polyaramide segments is a copolymer and includes a first segment including:

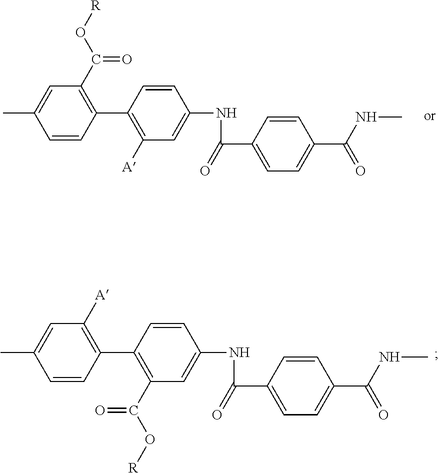

and a second segment including:

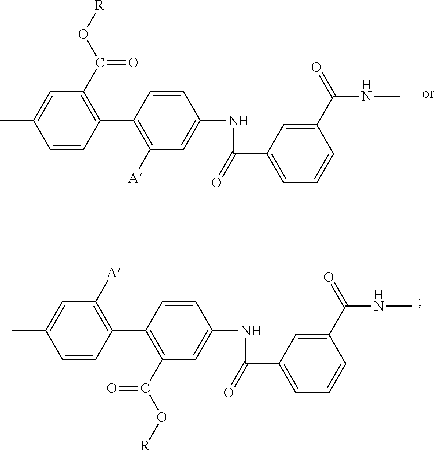

wherein R is a polyfunctional bridging group that comprises only covalent bonded fragments; A′ is independently selected from SO₃H, SO₃⁻, COOH, COO⁻, or COOR, or salts thereof; and further wherein the first segment and the second segment are connected by a covalent bond.

In some embodiments, a composition that includes polyaramide segments covalently cross-linked to other polyaramide segments can also include non-cross-linked segments. The non-cross-linked segments can include the following structures:

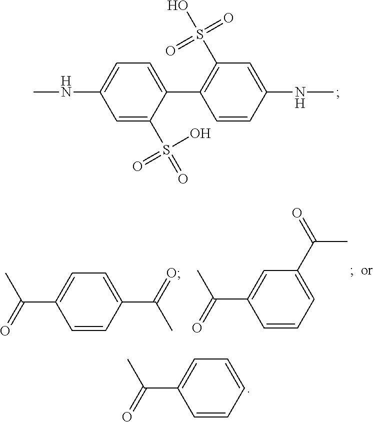

In one embodiment, a layer of water-soluble polyaramide that has been cross-linked by polyfunctional aziridine may be further treated with polyfunctional aziridine to form an additional coat or layer of polyaziridine. In another embodiment, a second coat of polyaramide cross-linked with polyfunctional aziridine may be formed over a first coat of polyaramide cross-linked with polyfunctional aziridine.

Coatings of Polyfunctional Aziridine

In one embodiment, a film or coating including a polyaramide is formed. In some embodiments, the film or coating is provided with an overcoat of polyfunctional aziridine. In some embodiments, the polyfunctional aziridine reacts with itself to form polyaziridine. In some embodiments, at least some of the polyfunctional aziridine reacts with polyaramide in the film or coating. In some embodiments, the reaction between the polyfunctional aziridine and the polyaramide occurs at an interface between the polyaziridine and the polyaramide.

In one embodiment, polyfunctional aziridine can be cross-linked to form an overcoat for a layer, film, or coating of polyaramide. For example, a solution of polyfunctional aziridine can be applied to a polyaramide film or coating. In some embodiments the film or coating of polyaramide is dried before the solution of polyfunctional aziridine is applied. In some embodiments, the solution of polyfunctional aziridine is allowed to dry. In some embodiments, the polyfunctional aziridine can be treated with an acid to form a hydrophobic surface. In one embodiment, the acid may be 3-5% HCl. A skilled artisan would recognize that other acids and other concentrations could also be used. In some embodiments, a layer of polyfunctional aziridine can provide an additional or second layer on a first layer that includes water-soluble polyaramide.

In some embodiments, polyfunctional aziridine can be overcoated with a carboxylic acid group-containing polyaramide, at which point the carboxylic acid groups will react with the surface aziridine functionality to make the polyaramide more hydrophobic. In one aspect the polyfunctional aziridine provides an aziridine reactive coating on a film or coating made of a carboxylic acid group-containing water-soluble polyaramide. In some embodiments, layers of polyaziridine can be provided both above and below a layer of polyaramide.

Properties of the Coatings or Films

In some embodiments, a water-soluble polyaramide cross-linked with a polyfunctional aziridine is used to form a coating or film. The film can be a free-standing film.

The wet coating or film is about 10 times thicker than the dry coating or film. In some embodiments, the dry coating or film can have a thickness ranging from about 10 nm to 100,000 nm, specifically from about 10 nm to about 10,000 nm, or even more specifically from about 80 nm to about 1,800 nm. In some embodiments, the thickness of the coating or film can be controlled by altering the viscosity of the solution containing polyfunctional aziridine, water-soluble polyaramide, and a volatile base.

In one embodiment, the coating or film can be used to form all or part of an optical element or the coating or film can be coated on an optical element. An optical element can be an optical film, a light guide, a retarder film, a diffuser film, a polarizing film, a color filter, and/or an anisotropic optical film. In some embodiments, the coating or film can be used to replace a polyimide film. In some embodiments, the coating or film may be incorporated in a liquid crystal display (LCD) assembly or LED light assembly.

In some embodiments, the coating or film may be transparent to light. For example, the coating or film may have a light transmittance of at least 50%, 60%, 70%, 80%, 85%, 90%, 95%, or 98%.

In some embodiments, the coating or film can refract light. In some embodiments, the coating or film can be optically anisotropic.

In some embodiments, the coating or film is thermally stable.

Objects and advantages of this disclosure are further illustrated by the following examples, but the particular materials and amounts thereof recited in these examples, as well as other conditions and details, should not be construed to unduly limit this disclosure.

### EXAMPLES

The following equipment was used in the following representative Examples.

1) Mayer Rod #8

2) 0.5-10 μl Transferpette S Pipette

3) 0.1-10 μl ULR non-sterile Tips

4) Convection Curing Oven

5) Mayer Rod Coating Table

6) Magnetic Stir Plate/Heater

7) Stir Rods (½″×⅛″)

8) Glass Vials (10 ml)

9) pH Meter

10) Glass pH Electrode (D=4.5 mm)

11) Substrate (clean glass (76.2 mm×101 mm×0.8 mm))

12) Camera Nikon D90 18-105 mm@75, 1:3.5-5.6G ED Glass VR

13) Heat Gun, 1500 W

14) Linearly polarized light table+linear polarizing filter

15) Surface profiler (Veeco DEKTAK 3ST)

16) Axometrics AxoScanTM Mueller Matrix Polarimeter equipped with;

17) Axometrics Automated Out-of-Plane Measurement Fixture PN: OPMF-2

18) Axometrics Light Source

All reagents, starting materials and solvents used in the following examples were purchased from commercial suppliers (such as Sigma-Aldrich Chemical Company, St. Louis, Mo.) and were used without further purification unless otherwise indicated.

### Example 1

Synthesis of Sample S1 proceeded by mixing 28.009 g (0.0814 mol) 4, 4′-diaminobiphenyl-2, 2′-disulfonic acid (DABS) and 17.151 g (0.063 mol) 4, 4′-diaminobiphenyl-2, 2′-dicarboxylic acid (DABC) in a glass beaker. (DABC was obtained from HAOHUA INDUSTRY CO., LTD., JINAN CITY, SHANDONG, CHINA) Deionized Water (DI Water—3.27 L) was added to the DABS/DABC mixture creating a slurry with an initial pH 3.26 at 23° C. The slurry was combined with Carbonate Buffer (Sodium salt—0.353 L/0.46M) and the pH was adjusted to 6.50 using the carbonate buffer to dissolve the mixture. The solution was transferred into a glass resin kettle.

While the DABS and DABC mixture was agitated at medium speed with a stainless steel (SS) agitator, toluene (1.35 L) was charged into the reactor and agitated until the mixture turned into a milky liquid (3 min). Once this milky liquid was formed, a solution of 27.076 g terephthaloyl chloride (TPC—0.133 mol) in toluene (1.35 L) was added all at once at double the initial agitation speed. Addition of TPC in toluene was reaction time point zero and agitation continued for 3 hours. Over the course of the reaction, Carbonate Buffer (0.325 L) was dosed into the reaction to maintain a pH between 6.00 and 7.00. At the end of 3 hours, the emulsion was slightly viscous and had a milky white color. The reaction mass was allowed to sit in an emulsified state overnight. Toluene was removed via distillation the following day. After distillation, the polymer was desalted using a membrane with a 20kDA molecular weight cutoff. The polymer solution was concentrated or diluted as necessary to prepare for coating. The observed molecular weight of the distilled material was 20,000 Da as determined by gel permeation chromatography (GPC) analysis of the resultant polymer mixture.

### Example 2

Synthesis of Sample S2 proceeded by mixing 43.018 g (0.125 mol) 4, 4′-diaminobiphenyl-2, 2′-disulfonic acid (DABS) and 11.408 g (0.0419 mol) 4, 4′-diaminobiphenyl-2, 2′-dicarboxylic acid (DABC) in a glass beaker. DI Water (0.835 L) was added to the DABS/DABC mixture creating a slurry with an initial pH 3.09 at 23° C. The slurry was combined with 0.110 L Carbonate Buffer (Sodium—0.99M) and the pH was adjusted to 6.43 using the carbonate buffer to dissolve the mixture. The solution was transferred into a glass resin kettle.

While the DABS and DABC mixture was agitated at medium speed with a SS agitator, toluene (0.303 L) was charged into the reactor and agitated until the mixture turned into a milky liquid (3 min). Once this milky liquid was formed, a solution of 20.485 g TPC (0.101 mol), 7.665 g isophthaloyl chloride (IPC—0.0377 mol), and 3.555 g benzoyl chloride (BC—0.0253 mol), was prepared in toluene (0.151 L). This solution was added all at once, using double the initial agitation speed. Addition of the acid chlorides solution was reaction time point zero and agitation continued for 15 minutes. Over the course of the reaction 0.118 L Carbonate Buffer was dosed into the reaction to maintain the pH between 5.83 and 6.43. At the end of 15 minutes, the emulsion had become very viscous, almost gel-like. The reaction mass was allowed to sit in an emulsified state for an additional 15 minutes. Toluene was distilled immediately after. After distillation, the polymer was desalted using a membrane with a 5 kDA molecular weight cutoff. The polymer solution was concentrated or diluted as necessary to prepare for coating. The observed molecular weight of the distilled material was ˜2,000 Da as determined by GPC analysis of the resultant polymer mixture.

### Example 3

Synthesis of Sample S3 proceeded by mixing 50.028 g (0.145 mol) 4, 4′-diaminobiphenyl-2, 2′-disulfonic acid (DABS) and 7.733 g (0.0284 mol) 4, 4′-diaminobiphenyl-2, 2′-dicarboxylic acid (DABC) in a glass beaker. DI Water (0.737 L) was added to the DABS/DABC mixture creating a slurry with an initial pH 3.10 at 23° C. The slurry was combined with 0.100 L Carbonate Buffer (Sodium—0.99M) and the pH was adjusted to 6.50 using the carbonate buffer to dissolve the mixture. The solution was transferred into a glass resin kettle.

While the DABS and DABC mixture was agitated at medium speed with a SS agitator, toluene (0.308 L) was charged into the reactor and agitated until the mixture turned into a milky liquid (3 min). Once this milky liquid was formed, a solution of 20.835 g TPC (0.103 mol), 7.721 g IPC (0.0380 mol), and 2.400 g maleic anhydride (MA—0.0245 mol), was prepared in toluene (0.157 L). This solution was added all at once, using double the initial agitation speed. Addition of the acid chloride solution was reaction time point zero and agitation continued for 15 minutes. Over the course of the reaction, 0.0900 L Carbonate Buffer was dosed into the reaction to maintain the pH between 5.93 and 6.11. At the end of 15 minutes, the emulsion had become very viscous, almost gel-like. The reaction mass was allowed to sit in an emulsified state for an additional 15 minutes. Toluene was distilled immediately after. After distillation, the polymer was desalted using a membrane with a 5 kDA molecular weight cutoff. The polymer solution was concentrated or diluted as necessary to prepare for coating. The observed molecular weight of the distilled material was ˜4,000 Da as determined by GPC analysis of the resultant polymer mixture.

### Examples 4-11

### Synthesis of Polymers with Other Amounts of DABC Content

Samples S4-S11 were synthesized in a similar manner to either Samples S1 or S2, as indicated in Table 1. There were two differences depending on the desired final state of the synthesized polymer. The first difference depended on the ratios of DABS to DABC starting reagents to result in the desired percentage of carboxylic acid in the backbone of the polymer (indicated in Table 1). The second difference was the desired cationic derivative of the polymer, which was achieved by using either sodium or ammonium carbonate buffer (indicated in Table 1).

TABLE 1

| | MW | DABC/DABS | Carbonate | |
|---|---|---|---|---|
| Sample | (kDA) | ratio | Buffer Type | IPC/TPC/BC/MA |
| S1 | 27.4 | 1:1 | Sodium | 0/1/0/0 |
| S2 | 2.69 | 3:7 | Sodium | 0.27/0.73/0/0.18 |
| S3 | 4.10 | 1:4 | Sodium | 0.27/0.73/0/0.18 |
| S4 | 41.0 | 1:1 | Sodium | 0/1/0/0 |
| S5 | 52.6 | 1:4 | Ammonium | 0/1/0/0 |
| S6 | 61.4 | 1:9 | Ammonium | 0/1/0/0 |
| S7 | 42.0 | 3:7 | Sodium | 0/1/0/0 |
| S8 | 7.37 | 1:0 | Sodium | 0/1/0/0 |
| S9 | 3.60 | 3:97 | Sodium | 0.27/0.73/0/0.18 |
| S10 | 2.40 | 1:9 | Ammonium | 0.27/0.73/0/0.18 |
| S11 | 2.69 | 3:7 | Sodium | 0.27/0.73/0/0.18 |

### Example 12

Formulation of Example 12 proceeded as follows: 1.672 g of 7.9% (w/w) polymer solution S9 was added to a glass vial with a Teflon coated stirbar and the sample was agitated. Initial pH was measured as 6.3, followed by pH adjustment with triethylamine (TEA) to pH 11.2. 100 μL of pentaerythritol-tris-3-(1-aziridinyl)-propionate (AZ1) was diluted to 2004. Diluted polyfunctional aziridine solution (3.284) was added to the vial containing agitated polymer and agitated for 10 minutes.

### Example 13

Formulation of Example 13 proceeded as follows: 2.109 g of 7.9% (w/w) polymer solution S9 was added to a glass vial with a Teflon coated stirbar and the sample was agitated at speed 1. Initial pH was measured as 6.3, followed by pH adjustment with triethylamine to pH 10.6. 100 μL of AZ1 was diluted to 200 μL. Diluted polyfunctional aziridine solution (8.27 μL) was added to the vial containing agitated polymer and agitated for 10 minutes.

### Example 14

Formulation of Example 14 proceeded as follows: 1.800 g of 7.9% (w/w) polymer solution S9 was added to a glass vial with a Teflon coated stirbar and the sample was agitated at speed 1. Initial pH was measured as 6.3, followed by pH adjustment with aqueous ammonia (NH₃ (Aq)) to pH 9.7. 100 μL of AZ1 was diluted to 200 μL. Diluted polyfunctional aziridine solution (3.53 μL ) was added to the vial containing agitated polymer and agitated for 10 minutes.

### Example 15

Formulation of Example 15 proceeded as follows: 1.944 g of 7.9% (w/w) polymer solution S9 was added to a glass vial with a Teflon coated stirbar and the sample was agitated at speed 1. Initial pH was measured as 6.3, followed by pH adjustment with aqueous ammonia to pH 9.4. 100 μL of AZ1 was diluted to 200 μL. Diluted polyfunctional aziridine solution (7.62 μL) was added to the vial containing agitated polymer and agitated for 10 minutes.

### Example 16

Formulation of Example 16 proceeded as follows: 1.483 g of 7.9% (w/w) polymer solution S9 was added to a glass vial with a Teflon coated stirbar and the sample was agitated at speed 1. Initial pH was measured as 6.3, followed by pH adjustment with triethylamine to pH 10.3. 100 μL of trimethylolpropane tris-(2-methyl-1-aziridine propionate) (AZ2) was diluted to 200 μL. Diluted polyfunctional aziridine solution (4.15 μL) was added to the vial containing agitated polymer and agitated for 10 minutes.

### Example 17

Formulation of Example 17 proceeded as follows: 2.120 g of 7.9% (w/w) polymer solution S9 was added to a glass vial with a Teflon coated stirbar and the sample was agitated at speed 1. Initial pH was measured as 6.3, followed by pH adjustment with triethylamine to pH 10.2. 100 μL of AZ2 was diluted to 200 μL. Diluted polyfunctional aziridine solution (11.88 μL) was added to the vial containing agitated polymer and agitated for 10 minutes.

### Example 18

Formulation of Example 18 proceeded as follows: 1.660 g of 7.9% (w/w) polymer solution S9 was added to a glass vial with a Teflon coated stirbar and the sample was agitated at speed 1. Initial pH was measured as 6.3, followed by pH adjustment with aqueous ammonia to pH 10.0. 100 μL of AZ2 was diluted to 200 μL. Diluted polyfunctional aziridine solution (4.65 μL) was added to the vial containing agitated polymer and agitated for 10 minutes.

### Example 19

Formulation of Example 19 proceeded as follows: 1.944 g of 7.9% (w/w) polymer solution S9 was added to a glass vial with a Teflon coated stirbar and the sample was agitated at speed 1. Initial pH was measured as 6.3, followed by pH adjustment with aqueous ammonia to pH 9.8. 100 μL of AZ2 was diluted to 200 μL. Diluted polyfunctional aziridine solution (10.89 μL) was added to the vial containing the solution and was agitated for 10 minutes.

### Examples 20-83

The formulations of Examples 20-83 were generally prepared as described in Examples 12-19 and as shown in Table 2 using Samples S1-S11 (prepared as described in Examples 1-11). Specifically, the sample (S1-S11) used for each Example is shown in column “Sample.” The weight of the sample used is shown in column “QTY_W (g).” In each instance, the sample was used in a solution at the w/w shown in column “Solid (%).” The solution was added to a glass vial with a Teflon coated stirbar and the sample was agitated at speed 1. The initial pH of the solution was measured and is shown in column “pH initial.” pH was adjusted using the base shown in column “Base” (either triethylamine (TEA) or aqueous ammonia (NH₃ (Aq)) to the pH shown in column “pH final.” Either pentaerythritol-tris-3-(1-aziridinyl)propionate (AZ1) or trimethylolpropane tris-(2-methyl-1-aziridine propionate) (AZ2) was added, as indicated in column “X-linker.” The AZ1 or AZ2 was diluted (1:1) in distilled water, and the volume added to the solution is shown in column “QTY (μl).” After addition of polyfunctional aziridine, the solution was agitated for 10 minutes.

Viscosity of the formulation before coating was evaluated and results are shown in column “Viscosity” of Table 3 where 0=low; 1=medium; and 2=high.

The formulations of Examples 12-83 were applied as a thin band (0.3 cm) across the width of a 7.6 cm×10.1 cm glass slide (previously cleaned to remove any particulate). The plate was then placed on a coating table (leveled) equipped with a coating rod. The rod was positioned between the short space of the end of the glass slide and the solution band. The rod was then pulled evenly toward the operator, creating an evenly distributed wet coating over the glass slide. The coated slide was transferred to a 90° C. preheated oven and placed flat and level on a glass support shelf for 10 minutes.

Each coated slide was positioned flat on the bench top. A drop (1 mL) of DI Water and a drop (1 mL) of 1% NaOH (aq) were simultaneously placed beside on either side of the center of the coated slide and allowed to remain on the slides for 5 minutes at 20° C. During treatment, each slide was placed between two linear polarizers where the polarizers were set at 90 degrees with respect to one another. The slide and polarizers were then back-lit with a diffused back light, and an image was taken using a camera. Then the plate was tilted to 90° and allowed the liquid drops to proceed down and off the plate. The slide was then placed 5.1 cm from a heat gun equipped with a slot tip and set to 49° C. The plate was placed at 45° and dried until all traces of moisture had been evaporated. A second image of the slide was then taken and then the slide was evaluated.

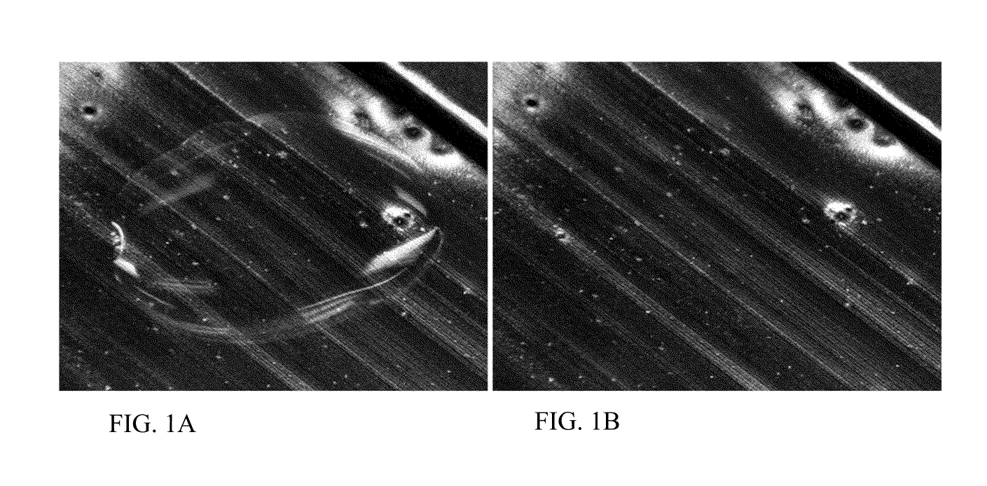

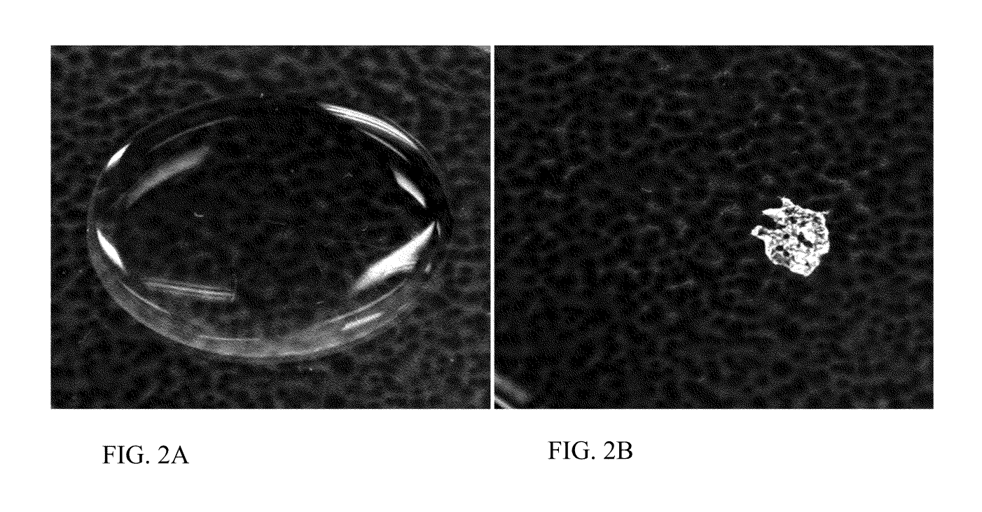

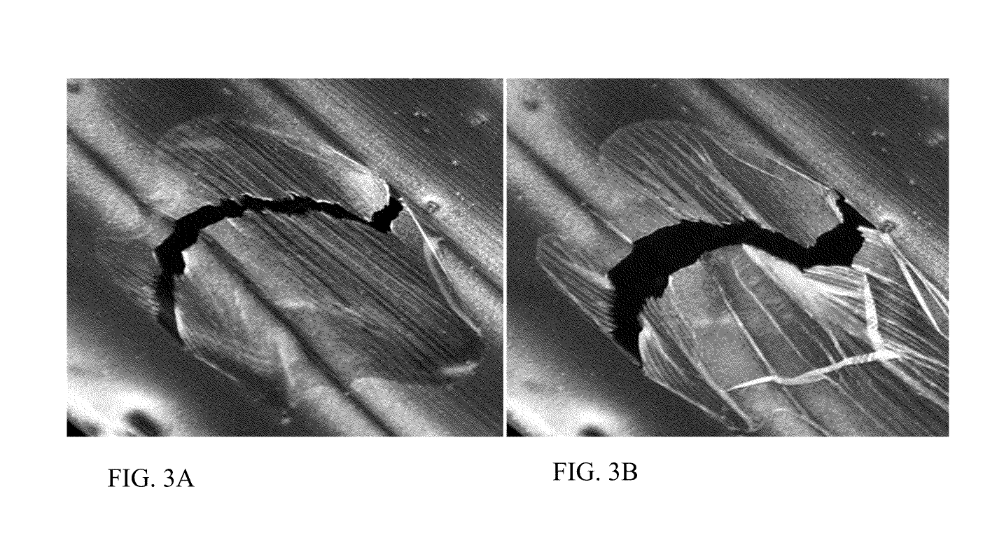

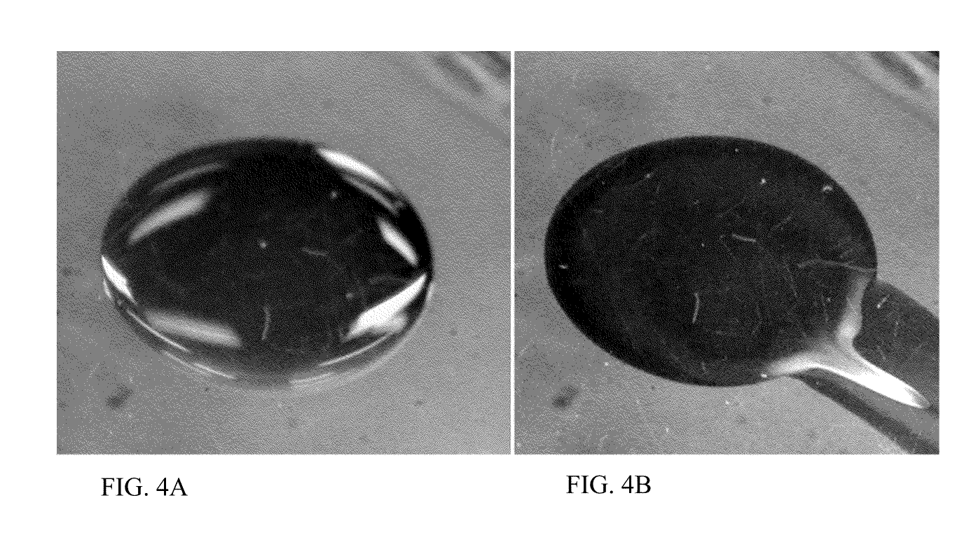

The coating on the slide after treatment was evaluated for resistance to water and results are shown in column “Sol H2O” of Table 3 where 1=stable, 2=defect (surface unbroken), 3=defect (surface broken), 4=hole. The coating on the slide after treatment was evaluated for resistance to NaOH and results are shown in column “Sol NaOH” of Table 3 where 1=stable, 2=defect (surface unbroken), 3=defect (surface broken), 4=hole. Each coated slide was placed between two linear polarizers where the polarizers were set at 90 degrees with respect to one another. The slide and polarizers were then back-lit with a diffused back light, and an image was taken. Exemplary images of slides during and after treatment are shown in FIGS. 1-4. Panel A corresponds to during treatment and Panel B corresponds to post-treatment and FIG. 1 corresponds to a rating of 1, FIG. 2 corresponds to a rating of 2, FIG. 3 corresponds to a rating of 3, and FIG. 4 corresponds to a rating of 4.

For certain samples, as shown in Table 3, the thickness of the coating was measured using a surface profiler. Thickness measurements are recorded in the column “Thickness (Å).”

For certain samples, as shown in Table 3, the optical qualities of the coating were measured using a two-axis out-of-plane retardance measurement with the following settings:
Curve fitting index: 1.6
Curve fitting thickness: measured per sample
Max tilt angle: 55 deg
Tilt angle increment: 5 deg
Number of measurements to average: 20
Number to average for orientation measurement: 20
Retardance order: 0
Measurement Wavelength: 550 nm
   Refractive indices are recorded in columns “nₓ”, “n_{y}”, and “n_{y}” of Table 3. Percent transmittance is recorded in column “T (%)” of Table 3.

### Examples 84-85

Sample C1, poly-(2,2′-disulfo-4,4′-benzidine terephthalamide-isophthalamide), sodium form, was prepared generally as described in Example 1 of U.S. Publication No. 2013/0251947 A1. Sample C2, poly-(2,2′-disulfo-4,4′-benzidine terephthalamide), sodium form, was prepared generally as described in Example 1 of Publication No. WO2014120505. The formulations of Examples 84 and 85 were prepared as shown in Table 2 using Samples C1 and C2.

The formulations of Examples 84-85 were applied as a thin band (0.3 cm) across the width of a 7.6 cm×10.1 cm glass slide (previously cleaned to remove any particulate). The plate was then placed on a coating table (leveled) equipped with a coating rod. The rod was positioned between the short space of the end of the glass slide and the solution band. The rod was then pulled evenly toward the operator, creating an evenly distributed wet coating over the glass slide. The coated slide was transferred to a 90° C. preheated oven and placed flat and level on a glass support shelf for 10 minutes.

Each coated slide was positioned flat on the bench top. A drop (1 mL) of DI Water and a drop (1 mL) of 1% NaOH (aq) were simultaneously placed beside on either side of the center of the coated slide and allowed to remain on the slides for 5 minutes at 20° C. During treatment, each slide was placed between two linear polarizers where the polarizers were set at 90 degrees with respect to one another. The slide and polarizers were then back-lit with a diffused back light, and an image was taken using a camera. Then the plate was tilted to 90° and allowed the liquid drops to proceed down and off the plate. The slide was then placed 5.1 cm from a heat gun equipped with a slot tip and set to 49° C. The plate was placed at 45° and dried until all traces of moisture had been evaporated. A second image of the slide was then taken and then the slide was evaluated.

The coating on the slide after treatment was evaluated for resistance to water and results are shown in column “Sol H2O” of Table 3 where 1=stable, 2=defect (surface unbroken), 3=defect (surface broken), 4=hole. The coating on the slide after treatment was evaluated for resistance to NaOH and results are shown in column “Sol NaOH” of Table 3 where 1=stable, 2=defect (surface unbroken), 3=defect (surface broken), 4=hole.

### Example 86

Sample C2 was dissolved in water so as to prepare 8.3 wt-% solution and coated onto substrate (primed (5% polyfunctional aziridine) glass 6.1 cm×7.6 cm×0.8 mm)) using a Mayer Rod #8 and a coating table. The produced coating was dried at 90° C. for 10 min. The dried substrate with coating was dipped into 5% solution of AZ1 (12.60 g) in Isopropyl Alcohol (247.5 g) for 5s followed by dipping into 0.3% solution of hydrochloric acid for 5 s. The coating was dried at 90° C. for 48 h. The coating was tested by placing 1 g of water on the coated and cured plate at room temperature for 5 minutes followed by visual inspection of the coating. The resulting rating (using the rating system described for Examples 20-83) was 1=stable.

### Example 87

Sample C1 was dissolved in water so as to prepare 5.5 wt-% solution and coated onto substrate (primed (5% polyfunctional aziridine) glass 6.1 cm×7.6 cm×0.8 mm)) using a Mayer Rod #8 and a coating table. The produced coating was dried at 90° C. for 10 min. The dried substrate with coating was dipped into 5% solution of AZ1 (12.60 g) in Isopropyl Alcohol (247.5 g) for 5s followed by dipping into 0.3% solution of hydrochloric acid for 5 s. The coating was dried at 90° C. for 25 min. The coating was tested by placing 1 g of water on the coated and cured plate at room temperature for 5 minutes followed by visual inspection of the coating. The resulting rating (using the rating system described for Examples 20-83) was 3=defect (surface broken).

TABLE 2

| | POLYMER | | | | | | | | BASE | | X-LINKER | | |
|---|---|---|---|---|---|---|---|---|---|---|---|---|---|
| | | | Solid | Main | End Cap | | MW | QTY_W | | pH | X- | | QTY |
| Example | Sample | pH initial | (%) | COOH | COOH | Ion | (kDa) | (g) | Base | final | Linker | EQV | (μl) |
| 12 | S9 | 6.3 | 7.9 | 3 | n/a | Na | 21.3 | 1.672 | TEA | 11.2 | AZ1 | 1 | 3.28 |
| 13 | S9 | 6.3 | 7.9 | 3 | n/a | Na | 21.3 | 2.109 | TEA | 10.6 | AZ1 | 2 | 8.27 |
| 14 | S9 | 6.3 | 7.9 | 3 | n/a | Na | 21.3 | 1.800 | NH₃ (Aq) | 9.7 | AZ1 | 1 | 3.53 |
| 15 | S9 | 6.3 | 7.9 | 3 | n/a | Na | 21.3 | 1.944 | NH₃ (Aq) | 9.4 | AZ1 | 2 | 7.62 |
| 16 | S9 | 6.3 | 7.9 | 3 | n/a | Na | 21.3 | 1.483 | TEA | 10.3 | AZ2 | 1 | 4.15 |
| 17 | S9 | 6.3 | 7.9 | 3 | n/a | Na | 21.3 | 2.120 | TEA | 10.2 | AZ2 | 2 | 11.88 |
| 18 | S9 | 6.3 | 7.9 | 3 | n/a | Na | 21.3 | 1.660 | NH₃ (Aq) | 10.0 | AZ2 | 1 | 4.65 |
| 19 | S9 | 6.3 | 7.9 | 3 | n/a | Na | 21.3 | 1.944 | NH₃ (Aq) | 9.8 | AZ2 | 2 | 10.89 |
| 20 | S10 | 5.0 | 6.1 | 10 | n/a | NH₄⁺ | 7.4 | 2.309 | TEA | 8.8 | AZ1 | 1 | 11.92 |
| 21 | S10 | 5.0 | 6.1 | 10 | n/a | NH₄⁺ | 7.4 | 2.142 | TEA | 8.7 | AZ1 | 2 | 22.12 |
| 22 | S10 | 5.0 | 6.1 | 10 | n/a | NH₄⁺ | 7.4 | 2.276 | NH₃ (Aq) | 9.0 | AZ1 | 1 | 11.52 |
| 23 | S10 | 5.0 | 6.1 | 10 | n/a | NH₄⁺ | 7.4 | 1.958 | NH₃ (Aq) | 8.8 | AZ1 | 2 | 19.83 |
| 24 | S10 | 5.0 | 6.1 | 10 | n/a | NH₄⁺ | 7.4 | 1.968 | TEA | 9.3 | AZ2 | 1 | 14.23 |
| 25 | S10 | 5.0 | 6.1 | 10 | n/a | NH₄⁺ | 7.4 | 2.383 | TEA | 9.2 | AZ2 | 2 | 34.47 |
| 26 | S10 | 5.0 | 6.1 | 10 | n/a | NH₄⁺ | 7.4 | 2.132 | NH₃ (Aq) | 8.9 | AZ2 | 1 | 15.42 |
| 27 | S10 | 5.0 | 6.1 | 10 | n/a | NH₄⁺ | 7.4 | 2.252 | NH₃ (Aq) | 8.8 | AZ2 | 2 | 32.58 |
| 28 | S3 | 3.6 | 4.7 | 20 | 20% | Na | 12.5 | 1.911 | TEA | 9.7 | AZ1 | 1 | 14.89 |
| 29 | S3 | 3.6 | 4.7 | 20 | 20% | Na | 12.5 | 1.788 | TEA | 8.8 | AZ1 | 2 | 27.87 |
| 30 | S3 | 3.6 | 4.7 | 20 | 20% | Na | 12.5 | 1.967 | NH₃ (Aq) | 9.1 | AZ1 | 1 | 15.33 |
| 31 | S3 | 3.6 | 4.7 | 20 | 20% | Na | 12.5 | 1.625 | NH₃ (Aq) | 9.3 | AZ1 | 2 | 25.33 |
| 32 | S3 | 3.6 | 4.7 | 20 | 20% | Na | 12.5 | 1.849 | TEA | 9.6 | AZ2 | 1 | 20.58 |
| 33 | S3 | 3.6 | 4.7 | 20 | 20% | Na | 12.5 | 1.797 | TEA | 10.6 | AZ2 | 2 | 40.01 |
| 34 | S3 | 3.6 | 4.7 | 20 | 20% | Na | 12.5 | 1.984 | NH₃ (Aq) | 9.2 | AZ2 | 1 | 22.09 |
| 35 | S3 | 3.6 | 4.7 | 20 | 20% | Na | 12.5 | 1.880 | NH₃ (Aq) | 9.2 | AZ2 | 2 | 41.86 |
| 36 | S11 | 4.0 | 7.0 | 30 | n/a | Na | 10.0 | 2.109 | TEA | 9.1 | AZ1 | 1 | 36.64 |
| 37 | S11 | 4.0 | 7.0 | 30 | n/a | Na | 10.0 | 1.699 | TEA | 9.1 | AZ1 | 2 | 59.03 |
| 38 | S11 | 4.0 | 7.0 | 30 | n/a | Na | 10.0 | 1.848 | NH₃ (Aq) | 8.8 | AZ1 | 1 | 32.10 |
| 39 | S11 | 4.0 | 7.0 | 30 | n/a | Na | 10.0 | 1.723 | NH₃ (Aq) | 8.7 | AZ1 | 2 | 59.87 |
| 40 | S11 | 4.0 | 7.0 | 30 | n/a | Na | 10.0 | 1.756 | TEA | 9.3 | AZ2 | 1 | 43.58 |
| 41 | S11 | 4.0 | 7.0 | 30 | n/a | Na | 10.0 | 1.700 | TEA | 9.2 | AZ2 | 2 | 84.38 |
| 42 | S11 | 4.0 | 7.0 | 30 | n/a | Na | 10.0 | 1.612 | NH₃ (Aq) | 8.7 | AZ2 | 1 | 40.01 |
| 43 | S11 | 4.0 | 7.0 | 30 | n/a | Na | 10.0 | 1.808 | NH₃ (Aq) | 8.7 | AZ2 | 2 | 89.74 |
| 44 | S4 | 5.6 | 7.0 | 50 | n/a | Na | 135 | 1.945 | TEA | 10.4 | AZ1 | 1 | 56.32 |
| 45 | S4 | 5.6 | 7.0 | 50 | n/a | Na | 135 | 2.049 | TEA | 10.1 | AZ1 | 2 | 118.66 |
| 46 | S4 | 5.6 | 7.0 | 50 | n/a | Na | 135 | 2.001 | NH₃ (Aq) | 9.0 | AZ1 | 1 | 57.94 |
| 47 | S4 | 5.6 | 7.0 | 50 | n/a | Na | 135 | 2.006 | NH₃ (Aq) | 9.0 | AZ1 | 2 | 116.17 |
| 48 | S4 | 5.6 | 7.0 | 50 | n/a | Na | 135 | 2.038 | TEA | 9.5 | AZ2 | 1 | 84.30 |
| 49 | S4 | 5.6 | 7.0 | 50 | n/a | Na | 135 | 2.125 | TEA | 10.0 | AZ2 | 2 | 175.80 |
| 50 | S4 | 5.6 | 7.0 | 50 | n/a | Na | 135 | 2.159 | NH₃ (Aq) | 9.1 | AZ2 | 1 | 89.31 |
| 51 | S4 | 5.7 | 7.0 | 50 | n/a | Na | 135 | 2.160 | NH₃ (Aq) | 9.1 | AZ2 | 2 | 178.70 |
| 52 | S1 | 5.7 | 7.0 | 50 | n/a | Na | 71 | 1.958 | TEA | 10.1 | AZ1 | 1 | 56.69 |
| 53 | S1 | 5.7 | 7.0 | 50 | n/a | Na | 71 | 2.024 | TEA | 10.6 | AZ1 | 2 | 117.21 |
| 54 | S1 | 5.7 | 7.0 | 50 | n/a | Na | 71 | 2.000 | NH₃ (Aq) | 9.2 | AZ1 | 1 | 57.91 |
| 55 | S1 | 5.7 | 7.0 | 50 | n/a | Na | 71 | 2.016 | NH₃ (Aq) | 9.2 | AZ1 | 2 | 116.74 |
| 56 | S1 | 5.7 | 7.0 | 50 | n/a | Na | 71 | 1.910 | TEA | 9.7 | AZ2 | 1 | 79.01 |
| 57 | S1 | 5.7 | 7.0 | 50 | n/a | Na | 71 | 2.188 | TEA | 10.7 | AZ2 | 2 | 181.01 |
| 58 | S1 | 5.7 | 7.0 | 50 | n/a | Na | 71 | 1.914 | NH₃ (Aq) | 9.5 | AZ2 | 1 | 79.17 |
| 59 | S1 | 5.1 | 7.0 | 50 | n/a | Na | 71 | 2.139 | NH₃ (Aq) | 9.5 | AZ2 | 2 | 176.96 |
| 60 | S5 | 5.1 | 7.0 | 20 | n/a | NH₄⁺ | 146 | 1.894 | TEA | 9.4 | AZ1 | 1 | 21.94 |
| 61 | S5 | 5.1 | 7.0 | 20 | n/a | NH₄⁺ | 146 | 1.783 | TEA | 9.5 | AZ1 | 2 | 41.30 |
| 62 | S5 | 5.1 | 7.0 | 20 | n/a | NH₄⁺ | 146 | 1.895 | NH₃ (Aq) | 9.4 | AZ1 | 1 | 21.95 |
| 63 | S5 | 5.1 | 7.0 | 20 | n/a | NH₄⁺ | 146 | 1.777 | NH₃ (Aq) | 9.4 | AZ1 | 2 | 41.16 |
| 64 | S5 | 5.1 | 7.0 | 20 | n/a | NH₄⁺ | 146 | 1.788 | TEA | 9.6 | AZ2 | 1 | 29.58 |
| 65 | S5 | 5.1 | 7.0 | 20 | n/a | NH₄⁺ | 146 | 1.750 | TEA | 9.5 | AZ2 | 2 | 57.91 |
| 66 | S5 | 5.1 | 7.0 | 20 | n/a | NH₄⁺ | 146 | 1.713 | NH₃ (Aq) | 9.3 | AZ2 | 1 | 28.34 |
| 67 | S5 | 4.9 | 7.0 | 20 | n/a | NH₄⁺ | 146 | 1.697 | NH₃ (Aq) | 9.3 | AZ2 | 2 | 56.16 |
| 68 | S6 | 4.9 | 7.0 | 10 | n/a | NH₄⁺ | 161 | 1.830 | TEA | 9.5 | AZ1 | 1 | 10.60 |
| 69 | S6 | 4.9 | 7.0 | 10 | n/a | NH₄⁺ | 161 | 1.696 | TEA | 9.3 | AZ1 | 2 | 19.64 |
| 70 | S6 | 4.9 | 7.0 | 10 | n/a | NH₄⁺ | 161 | 1.900 | NH₃ (Aq) | 9.3 | AZ1 | 1 | 11.00 |
| 71 | S6 | 4.9 | 7.0 | 10 | n/a | NH₄⁺ | 161 | 1.770 | NH₃ (Aq) | 9.4 | AZ1 | 2 | 20.50 |
| 72 | S6 | 4.9 | 7.0 | 10 | n/a | NH₄⁺ | 161 | 1.880 | TEA | 9.3 | AZ2 | 1 | 15.55 |
| 73 | S6 | 4.9 | 7.0 | 10 | n/a | NH₄⁺ | 161 | 1.692 | TEA | 9.4 | AZ2 | 2 | 28.00 |
| 74 | S6 | 4.9 | 7.0 | 10 | n/a | NH₄⁺ | 161 | 1.772 | NH₃ (Aq) | 9.4 | AZ2 | 1 | 14.66 |
| 75 | S6 | 6.0 | 7.0 | 10 | n/a | NH₄⁺ | 161 | 1.796 | NH₃ (Aq) | 9.3 | AZ2 | 2 | 29.72 |
| 76 | S7 | 6.0 | 7.0 | 30 | n/a | Na | 138 | 1.914 | TEA | 10.6 | AZ1 | 1 | 33.25 |
| 77 | S7 | 6.0 | 7.0 | 30 | n/a | Na | 138 | 1.700 | TEA | 11.3 | AZ1 | 2 | 59.07 |
| 78 | S7 | 6.0 | 7.0 | 30 | n/a | Na | 138 | 1.849 | NH₃ (Aq) | 9.8 | AZ1 | 1 | 32.12 |
| 79 | S7 | 6.0 | 7.0 | 30 | n/a | Na | 138 | 1.695 | NH₃ (Aq) | 9.7 | AZ1 | 2 | 58.89 |
| 80 | S7 | 6.0 | 7.0 | 30 | n/a | Na | 138 | 1.816 | TEA | 11.2 | AZ2 | 1 | 45.07 |
| 81 | S7 | 6.0 | 7.0 | 30 | n/a | Na | 138 | 1.747 | TEA | 10.8 | AZ2 | 2 | 86.72 |
| 82 | S7 | 6.0 | 7.0 | 30 | n/a | Na | 138 | 1.798 | NH₃ (Aq) | 9.9 | AZ2 | 1 | 44.62 |
| 83 | S7 | 6.9 | 7.0 | 30 | n/a | Na | 138 | 1.756 | NH₃ (Aq) | 10.0 | AZ2 | 2 | 87.16 |
| 84 | C1 | 7.8 | 5.5 | 0 | n/a | Na | 5.8 | n/a | n/a | n/a | n/a | n/a | n/a |
| 85 | C2 | 7.6 | 8.3 | 0 | n/a | Na | 126 | n/a | n/a | n/a | n/a | n/a | n/a |

TABLE 3

| | MECHANICAL RESULTS* | | | | | | | |
|---|---|---|---|---|---|---|---|---|
| | | Sol | Sol | | OPTICAL RESULTS | | | |
| Example | Thickness (Å) | H2O | NaOH | Viscosity | nₓ | n_{y} | n_{z} | T (%) |
| 12 | 12750 | 4 | 4 | 2 | — | — | — | — |
| 13 | 24000 | 4 | 4 | 2 | — | — | — | — |
| 14 | 12400 | 4 | 4 | 2 | — | — | — | — |
| 15 | 13400 | 4 | 4 | 2 | — | — | — | — |
| 16 | 12800 | 4 | 4 | 1 | — | — | — | — |
| 17 | 12700 | 4 | 4 | 1 | — | — | — | — |
| 18 | 13300 | 4 | 4 | 1 | — | — | — | — |
| 19 | 15700 | 4 | 4 | 1 | — | — | — | — |
| 20 | 8500 | 4 | 4 | 1 | — | — | — | — |
| 21 | 800 | 4 | 4 | 1 | — | — | — | — |
| 22 | 9850 | 4 | 4 | 1 | — | — | — | — |
| 23 | 15500 | 4 | 4 | 1 | — | — | — | — |
| 24 | 10150 | 4 | 4 | 1 | — | — | — | — |
| 25 | 11200 | 4 | 4 | 1 | — | — | — | — |
| 26 | 8950 | 4 | 4 | 1 | — | — | — | — |
| 27 | 8800 | 4 | 4 | 1 | — | — | — | — |
| 28 | — | 1 | 4 | 0 | — | — | — | — |
| 29 | — | 1 | 4 | 0 | — | — | — | — |
| 30 | — | 1 | 4 | 0 | — | — | — | — |
| 31 | — | 1 | 4 | 0 | — | — | — | — |
| 32 | — | 1 | 3 | 0 | — | — | — | — |
| 33 | — | 1 | 3 | 0 | — | — | — | — |
| 34 | — | 1 | 3 | 0 | — | — | — | — |
| 35 | | 1 | 3 | 0 | — | — | — | — |
| 36 | 11800 | 1 | 4 | 2 | 1.713 | 1.712 | 1.615 | 89 |
| 37 | — | 1 | 4 | 2 | — | — | — | — |
| 38 | — | 1 | 4 | 1.5 | — | — | — | — |
| 39 | — | 1 | 4 | 1.5 | — | — | — | — |
| 40 | — | 1 | 2 | 1 | — | — | — | — |
| 41 | — | 1 | 2 | 1 | — | — | — | — |
| 42 | — | 1 | 2 | 1 | — | — | — | — |
| 43 | — | 1 | 2 | 1 | — | — | — | — |
| 44 | 12600 | 1 | 4 | 1 | — | — | — | — |
| 45 | 14600 | 1 | 3 | 1 | — | — | — | — |
| 46 | 13300 | 1 | 4 | 1 | — | — | — | — |
| 47 | 15150 | 1 | 3 | 1 | — | — | — | — |
| 48 | 16400 | 1 | 2 | 0.5 | — | — | — | — |
| 49 | 14700 | 1 | 3 | 0.5 | — | — | — | — |
| 50 | 16300 | 1 | 3 | 0.5 | — | — | — | — |
| 51 | 14850 | 1 | 3 | 0.5 | — | — | — | — |
| 52 | 18200 | 1 | 4 | 1 | — | — | — | — |
| 53 | 10900 | 1 | 3 | 1 | — | — | — | — |
| 54 | 10400 | 1 | 4 | 1 | — | — | — | — |
| 55 | 12300 | 1 | 3 | 1 | 1.821 | 1.614 | 1.605 | 75 |
| 56 | 9700 | 1 | 2 | 1 | — | — | — | — |
| 57 | 10050 | 1 | 3 | 1 | — | — | — | — |
| 58 | 11000 | 1 | 2 | 1 | — | — | — | — |
| 59 | 12150 | 1 | 3 | 1 | — | — | — | — |
| 60 | 11150 | 1 | 4 | 1 | 1.837 | 1.608 | 1.594 | 89 |
| 61 | — | 1 | 4 | 1 | — | — | — | — |
| 62 | 8850 | 1 | 4 | 1 | — | — | — | — |
| 63 | — | 1 | 4 | 1 | — | — | — | — |
| 64 | — | 1 | 4 | 1 | — | — | — | — |
| 65 | — | 1 | 3 | 1 | — | — | — | — |
| 66 | — | 1 | 4 | 1 | — | — | — | — |
| 67 | — | 1 | 3 | 1 | — | — | — | — |
| 68 | — | 4 | 4 | 1.5 | — | — | — | — |
| 69 | — | 1 | 4 | 1.5 | — | — | — | — |
| 70 | — | 4 | 4 | 1.5 | — | — | — | — |
| 71 | — | 1 | 4 | 1.5 | — | — | — | — |
| 72 | — | 4 | 4 | 1.5 | — | — | — | — |
| 73 | — | 3 | 4 | 1.5 | — | — | — | — |
| 74 | — | 4 | 4 | 1.5 | — | — | — | — |
| 75 | — | 4 | 4 | 1.5 | — | — | — | — |
| 76 | — | 3 | 4 | 0.5 | — | — | — | — |
| 77 | — | 1 | 3 | 0.5 | — | — | — | — |
| 78 | — | 1 | 3 | 0.5 | — | — | — | — |
| 79 | — | 1 | 3 | 0.5 | — | — | — | — |
| 80 | — | 3 | 2 | 0 | — | — | — | — |
| 81 | — | 3 | 3 | 0 | — | — | — | — |
| 82 | — | 3 | 3 | 0 | — | — | — | — |
| 83 | — | 3 | 3 | 0 | — | — | — | — |
| 84 | — | 4 | 4 | 0.5 | — | — | — | — |
| 85 | — | 4 | 4 | 0.5 | — | — | — | — |

Thus, embodiments of INSOLUBILIZATION OF WATER-SOLUBLE POLYARAMIDE BY CROSS-LINKING WITH POLYFUNCTIONAL AZIRIDINE are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

1. A water-insoluble composition comprising polyaramide segments covalently cross-linked to other polyaramide segments wherein a covalently cross-linked segment comprises 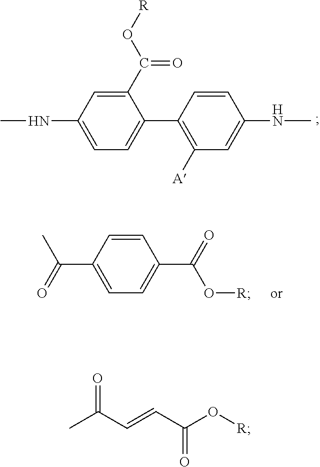
wherein R is a polyfunctional bridging group that comprises only covalent bonded fragments, and A′ is independently selected from SO₃H, SO₃⁻, COOH, COO⁻, or COOR, or salts thereof.

2. The composition of claim 1 wherein R is covalently bonded to at least 2 polyaramide segments.

3. A coating comprising the water-insoluble composition of claim 1.

4. The coating of claim 3 wherein the coating is optically anisotropic.

5. The water-insoluble composition of claim 1 wherein R comprises a reaction product of a polyfunctional aziridine.

6. The water-insoluble composition of claim 1 wherein the polyaramide comprises at least one of the following segments: 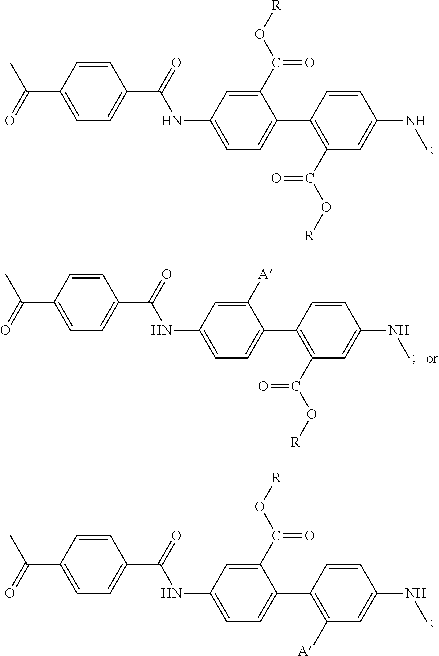
wherein R is a polyfunctional bridging group that comprises only covalent bonded fragments, and A′ is independently selected from SO₃H, SO₃⁻, COOH, COO⁻, or COOR, or salts thereof.

7. The water-insoluble composition of claim 1 wherein the polyaramide comprises: 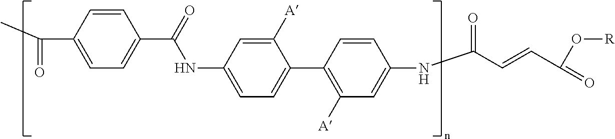
wherein n is an integer between 2 and 10,000; R is a polyfunctional bridging group that comprises only covalent bonded fragments; and A′ is independently selected from SO₃H, SO₃⁻, COOH, COO⁻, or COOR, or salts thereof.

8. The water-insoluble composition of claim 1 wherein the polyaramide comprises a copolymer comprising a first segment comprising: 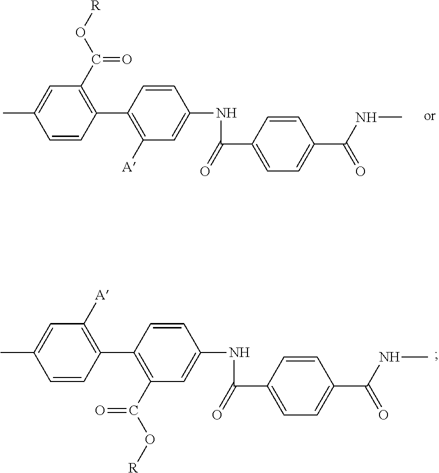
and a second segment comprising: 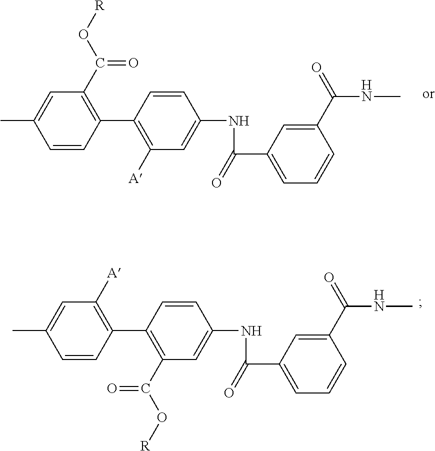
wherein R is a polyfunctional bridging group that comprises only covalent bonded fragments; and A′ is independently selected from SO₃H, SO₃⁻, COOH, COO⁻, or COOR, or salts thereof; and further wherein the first segment and the second segment are connected by a covalent bond.

9. The water-insoluble composition of claim 1 further comprising a volatile base.

10. The water-insoluble composition of claim 1 wherein R comprises

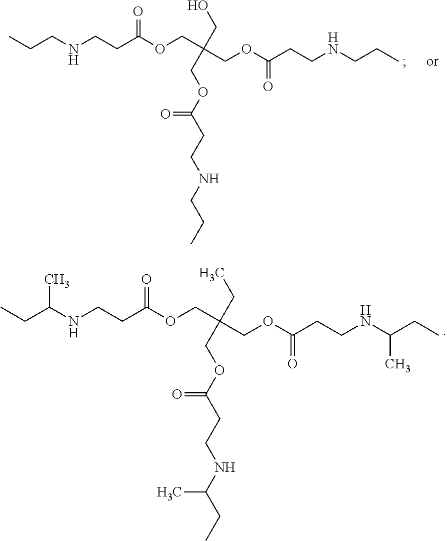

11. An article comprising an optical element comprising the water-insoluble composition of claim 1.

12. A film comprising the water-insoluble composition of claim 1.

13. The film of claim 12 wherein the film is optically anisotropic.

14. An article comprising:
a first layer comprising a polyaramide; and
a second layer comprising a polyfunctional bridging group, wherein the second layer is adjacent to the first layer at an interface.

15. The article of claim 14 wherein the polyfunctional bridging groups are covalently bonded to the polyaramides at the interface.

16. The article of claim 14 wherein the polyaramide comprises at least one of the following segments: 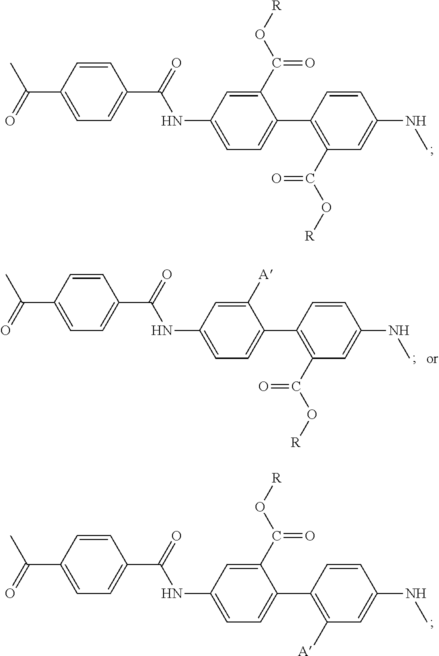
wherein R is a polyfunctional bridging group that comprises only covalent bonded fragments and A′ is independently selected from SO₃H, SO₃⁻, COOH, COOH⁻, or COOR, or salts thereof.

17. The article of claim 15 wherein the polyaramide comprises a copolymer comprising a first segment comprising: 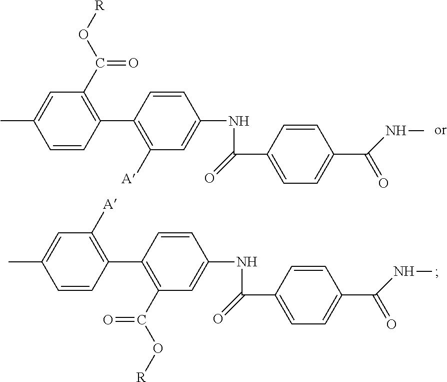
and a second segment comprising: 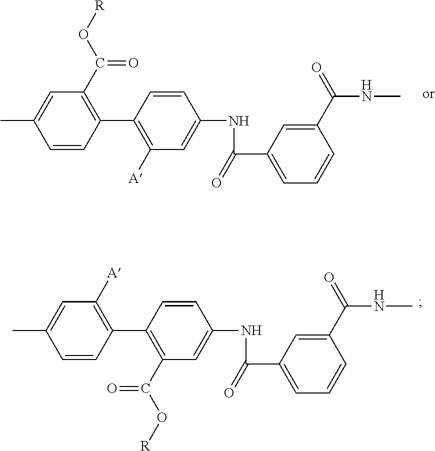
wherein R is a polyfunctional bridging group that comprises only covalent bonded fragments; A′ is independently selected from SO₃H, SO₃⁻, COOH, COH⁻, or COOR, or salts thereof; and
further wherein the first segment and the second segment are connected by a covalent bond.

18. An optical element comprising the article of claim 14.

19. A method comprising
combining a water-soluble polyaramide comprising a carboxylic acid group with a polyfunctional aziridine to form a mixture; and
cross-linking the water-soluble polyaramide with the polyfunctional aziridine to form a water-insoluble polyaramide.

20. The method of claim 19 further comprising adding a volatile base to the mixture.

21. The method of claim 19 wherein the polyaramide comprises 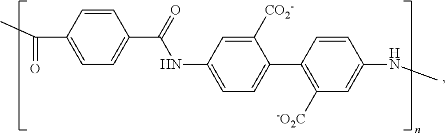
wherein n is an integer between 2 and 10,000.

22. The method of claim 19 further comprising coating the mixture on a substrate.

23. The method of claim 19 wherein the polyaramide comprises a copolymer comprising a segment comprising the following formula: 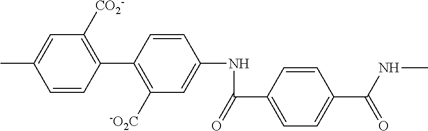
and a segment comprising the following formula: 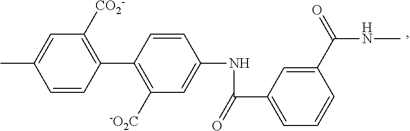
wherein the segments are connected by a covalent bond.

24. The method of claim 19 further comprising coating the mixture on an optical element.

25. The method of claim 19 wherein the cross-linking comprises heating the mixture.

26. The method of claim 19 wherein the cross-linking comprises reducing the pH of the mixture.

27. The method of claim 19 further comprising coating a layer of polyfunctional aziridine onto the mixture before the cross-linking step and cross-linking the layer of polyfunctional aziridine simultaneously with the cross-linking step.

28. The method of claim 19 further comprising coating a layer of polyfunctional aziridine onto the mixture after the cross-linking step and then cross-linking the layer of polyfunctional aziridine.

29. An optical element formed by the method according to claim 19.
